(19) United States
(12) Patent Application Publication
(10) Pub. No.: US 2019/0283277 A1
(43) Pub. Date: Sep. 19, 2019

(54) Tow Stabilization Method and Apparatus

(71) Applicant: Impossible Objects, Inc., Northbrook, IL (US)

(72) Inventors: Robert Swartz, Highland Park, IL (US); John Bayldon, Evanston, IL (US); Buckley Crist, Wilmette, IL (US); Eugene Gore, Des Plaines, IL (US)

(73) Assignee: Impossible Objects, Inc., Northbrook, IL (US)

(21) Appl. No.: 16/194,279

(22) Filed: Nov. 16, 2018

Related U.S. Application Data
(63) Continuation of application No. 14/566,661, filed on Dec. 10, 2014, now abandoned.
(60) Provisional application No. 61/914,163, filed on Dec. 10, 2013.

(51) Int. Cl. B29B 15/10; D04H 3/12; D04H 3/04

(52) U.S. Cl. CPC B29B 15/105; B29K 2105/251; D04H 3/04; D04H 3/12

(57) ABSTRACT

A tow stabilization method includes applying liquid to a tow having fibers arranged into a non-stabilized spread-out fiber web, applying powder to the web to adhere the powder where liquid was applied, removing powder from where it did not adhere, and fusing the powder remaining on the web to stabilize the fiber arrangement. The liquid may be volatile. The step of fusing may include heating the fiber web. The liquid and/or powder may be selectively applied. Selective application of powder may be used without application of liquid or powder removal. A tow stabilization apparatus includes a liquid applicator, powder applicator, powder remover, and powder fuser. The liquid applicator may include spray nozzles, applicators based on miniature solenoid valves, inkjet printing heads, and roll applicators. The powder remover may include rollers, air blasters, vibrators, sound wave generators, and vacuums. The powder fuser may include heat applicators and chemical reaction initiators.

### RELATED APPLICATIONS

This application is a continuation of U.S. patent application Ser. No. 14/566,661, filed Dec. 10, 2014, which claims the benefit of U.S. Provisional Application Ser. No. 61/914,163, filed Dec. 10, 2013, the entire disclosure of which is herein incorporated by reference.

### FIELD OF THE TECHNOLOGY

The present invention relates to manufacture of composite materials and, in particular, to stabilization of fiber webs.

### BACKGROUND

When processing fiber for the manufacture of composite materials, one of the many processing forms available is a spread fiber tow. For a typical spread fiber tow, a tow of fiber comprising approximately 1,000 to more than 24,000 individual filaments is spread out to form a uniform web, preferably of only a single fiber thickness. These fibers must then be stabilized in some way for ongoing processing.

In earlier composites manufactured from pre-impregnated fibers (“pre-preg” materials), the resin was applied immediately while the tow was in its spread form. However, increased used of processes in which the resin is impregnated into material formed from ‘dry’ (non-impregnated) fabrics drive a need to create stabilized spread tows. Several methods have been used previously, the most common being the application of a small quantity of polymeric resin to the dry material. Particular prior implementations have included spin bonding, in which spinnerets apply a thin bead of polymer to the surface of the material, and the use of thin thermoplastic threads heat-fused to the fiber web.

One challenge with these prior methods is that the polymer applied must be compatible with the infusion resin used for the final processing step. Since the most common use for the dry fabrics is in manufacture of fiber reinforced thermosetting materials, one common stabilizing material is uncatalyzed bisphenol-alkyl epoxy resin. This may be applied in the form of a spun filament, a solvent borne spray, or transferred from a paper backing.

### SUMMARY

In a preferred embodiment of the present method, a powdered polymer is applied to a fiber web and subsequently heated to fuse the material. This serves to stabilize the web. In a preferred embodiment, the reinforcement fiber passes under a spray or print head, which applies a controlled spray of fluid, which may include water, water with 2-pyrrolidone, glycol, oil, and/or other suitable fluids. After application of the fluid, a powdered polymeric resin is applied to the fiber web, the polymer adheres to the fluid, and any excess powder is removed. The web is then heated to melt the polymer and allowed to cool, leaving a stabilized fiber web.

In one aspect, a method for tow stabilization according to the invention includes the steps of applying liquid to a spread fiber tow, the spread fiber tow comprising a plurality of fibers arranged into a non-stabilized spread-out fiber web; applying powder to the fiber web to adhere the powder to areas of the fiber web where liquid was applied; removing powder from areas of the fiber web to which powder did not adhere; and fusing the powder remaining on the fiber web to stabilize the arrangement of the fibers. The liquid may be volatile, and may include water with 2-Pyrrolidone, glycol, or oil. The step of fusing may comprise heating the fiber web or a chemical reaction. The liquid and/or the powder may be selectively or intermittently applied. The powder may be a polymer, thermosettable powder, nylon, polyethylene, and/or polyether ether ketone. The fibers may be carbon fibers, ceramics, polymers, fiberglass, polyester, silk, nylon, aramid, spectra, polyethylene, and/or cotton.

In another aspect, a method for tow stabilization according to the invention includes the steps of applying powder in an intermittent pattern to a spread fiber tow, the spread fiber tow comprising a plurality of fibers arranged into a non-stabilized spread-out fiber web; and fusing the powder on the fiber web to stabilize the arrangement of the fibers. This method may be used with or without prior application of liquid to the web.

In yet another aspect, an apparatus for tow stabilization according to the invention includes a liquid applicator specially adapted to apply liquid to a spread fiber tow, a powder applicator specially adapted to apply powder to the fiber web so that powder adheres to areas of the fiber web where liquid was applied, a powder remover specially adapted to remove powder from areas of the fiber web to which powder did not adhere, and a powder fuser specially adapted to fuse the powder remaining on the fiber web so that the arrangement of the fibers is stabilized. The liquid applicator may include one or more spray nozzles, applicators based on miniature solenoid valves, inkjet printing heads, and/or roll applicators. The powder remover may include one or more beater or bump rollers, air blasters, vacuums, vibrators, or sound wave generators. The powder fuser may include one or more heat applicators and chemical reaction initiators.

### BRIEF DESCRIPTION OF THE DRAWINGS

Other aspects, advantages and novel features of the invention will become more apparent from the following detailed description of the invention when considered in conjunction with the accompanying drawings wherein:

FIG. 1 is a process flow chart of a preferred embodiment of the process of the invention;

FIG. 2 is an exemplary pattern of liquid application, in the form of elliptical dots, according to one aspect of the invention;

FIG. 3 depicts an exemplary implementation of an apparatus for liquid application wherein the liquid is applied in lines, according to one aspect of the invention;

FIG. 4 depicts an exemplary implementation of an apparatus for powder application and excess removal, according to one aspect of the invention; and

FIG. 5 depicts an alternative exemplary implementation of an apparatus for powder application and excess removal, wherein powder is applied intermittently, according to one aspect of the invention.

### DETAILED DESCRIPTION

Spread fiber tows are formed by taking a fiber tow, typically comprising from a few to multiple thousands of fibers, and spreading the fibers out using any of a variety of methods known in the art. The spread tow must be stabilized to allow subsequent processing without the tow collapsing back to the un-spread form. In a preferred embodiment of the method and apparatus for tow stabilization according to the present invention, a powdered polymer is applied to a fiber web and then subsequently heated to fuse the material, thereby stabilizing the web.

In a preferred embodiment, the present method employs four steps to stabilize the tow. In this embodiment, the fiber passes under a spray or print head, which applies a controlled spray of fluid. After application of the fluid, a powdered polymeric resin is applied to the fiber web, the polymer adheres to the fluid, and any excess powder is removed. The web is then heated to melt the polymer and allowed to cool, thereby creating a stabilized web.

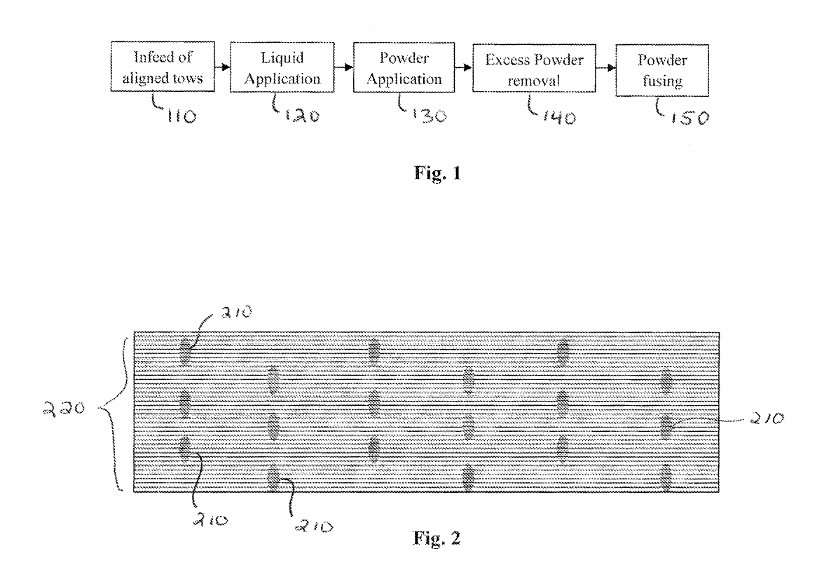

FIG. 1 is an overview process flow chart of a preferred embodiment of the tow stabilization process of the invention. A more detailed description of each of the steps of FIG. 1 follows below. As seen in FIG. 1, after infeed 110 of the aligned tows, a liquid is applied 120 to the fiber tow. Powder is applied 130, excess powder is removed 140, and the resulting compound is fused 150.

It will be clear to one of ordinary skill in the art of the invention that, while specific examples are provided in conjunction with the description of preferred embodiments that follows, many types of materials and patterns are suitable for use in the process and are therefore to be considered as being within the scope of the invention. Further, while the invention is described herein as using spread fiber tows as the basis for the stabilized web, it will be clear to one of ordinary skill in the art of the invention that the method and apparatus of the invention may be advantageously employed to stabilize woven fiber webs, such as, for example but not limited to, woven fiber webs having polyester thread or other suitable material holding the fibers together. The invention may also be advantageously employed to stabilize unidirectional materials.

Step 1. Application 120 of fluid. In this step, a volatile fluid is selectively applied to one or both sides of the fiber tow. This may be done using any of the variety of means known in the art, including, but not limited to: spray nozzles, applicators based on miniature solenoid valves, inkjet printing heads, and roll applicators. Typical materials used in fiber tows include, but are not limited to, carbon fiber, ceramics, polymers, fiberglass, polyester, silk, nylon, aramid, spectra, polyethylene, and/or cotton. While a volatile fluid is used in the described embodiment, it will be clear to one of ordinary skill in the art of the invention that other types of liquids are suitable for use in the process, in conjunction with appropriate removal methods, and are therefore to be considered as being within the scope of the invention. Suitable fluids include, but are not limited to water, water with 2-pyrrolidone, glycols, and oils.

Selective application allows the fluid to be applied in a variety of patterns designed to assist in easy processing of the final tow. Suitable patterns may include, but are not limited to, a series of bands perpendicular to the fiber direction, a series of bands at some angle to the fiber direction, a series of dots, and any other printed pattern. For example, FIG. 2 depicts a pattern of elliptical dots 210, wherein each dot overlaps many fibers 220 and also slightly overlaps its nearest neighbors along the fiber direction. This exemplary pattern maintains stability without restricting the flexibility of the tow.

Step 2. Powder application 130. Next, powder is applied to the moving band of fibers. The formulation and application rate of the previously applied fluid is such that a layer of powder adheres to the areas where fluid has been applied. The total quantity of powder applied in any area can be controlled by changing the particle size or particle size distribution, or by changing the quantity or formulation of fluid applied. Suitable powders include, but are not limited to, polymer, thermosettable powder, nylon, polyethylene, and polyether ether ketone.

Step 3. Excess powder removal 140. Excess powder is then removed, typically mechanically. A variety of devices and processes can be used for this step, including, but not limited to, a beater or bump roller, air blast, vacuum, vibration, and/or sound waves. This leaves a layer of powder attached to the fiber web in the areas where fluid was applied. Residual power can then optionally be recycled by the system.

Step 4. Powder fusing 150. The final step of the process is to treat the fiber web so that the powder melts and flows over, or is otherwise fused to, the fiber web, and to remove any remaining application fluid. In a preferred embodiment, the fluid is volatilized, but it will be clear to one of ordinary skill in the art of the invention that non-volatile liquids are suitable for use in the process and may be removed by any suitable removal method known in the art.

In a preferred embodiment, the powder is fused by application of heat, but it will be clear to one of ordinary skill in the art of the invention that other fusing methods are suitable for use in the process and are to be considered within the scope of the invention. Example alternatives include, but are not limited to, various types of chemical reactions. The temperature required for this step when fusing by the heat set method depends on the polymer or other material used, for example a high density polyethylene would require a temperature of around 250° F. This heat may be applied by any of the many suitable methods known in the art of the invention, such as, but not limited to, passing the web through an oven, over a hot plate, over a heated roller, through a pair of heated pinch rollers, or under a set of heater lights.

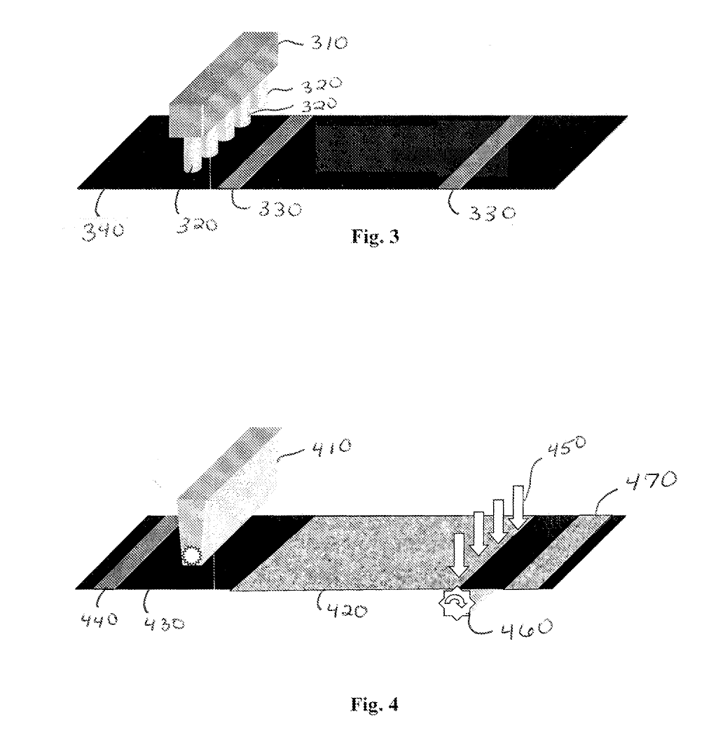

Exemplary apparatus suitable for preforming various steps of the process according to the invention are depicted in FIGS. 3-5. FIG. 3 depicts an exemplary implementation of an apparatus for liquid application, wherein the liquid is applied in lines. In the embodiment of FIG. 3, an ink jet head 310 comprising an array of jet nozzles 320 applies liquid 330 onto material to be stabilized 340 as it is fed through the apparatus. While a particular apparatus for liquid application is depicted in FIG. 3, it will be clear to one of ordinary skill in the art of the invention that any of the many alternative applicators for applying liquids are suitable for use in the process of the invention including, but not limited to, spray nozzles, inkjet printing heads, and roll applicators. It is further clear that any of a large variety of application patterns would also be suitable, with the choice typically being influenced by the specific application for which the process is being employed.

FIG. 4 depicts an exemplary implementation of an apparatus for powder application and excess removal. In the embodiment of FIG. 4, powder application system 410 continuously applies powder 420 to the feed 430 of material that has previously had liquid 440 applied. Excess powder is removed by vacuum system or air jets 450 and/or by bump roller 460 that mechanically removes the excess, leaving behind powder only in areas 470 where liquid had previously been applied. While particular apparatus for powder application and excess powder removal are depicted in FIG. 4, it will be clear to one of ordinary skill in the art of the invention that any of the many applicators for applying powders are suitable for use in the process of the invention, and that any application pattern for the powder, including intermittent application rather than continuous application, would also be suitable. It will further be clear that any other of the large variety of mechanisms for excess powder removal are also suitable for use in the invention, including, but not limited to, a beater roller, air blast, vacuum, vibration, and/or sound waves.

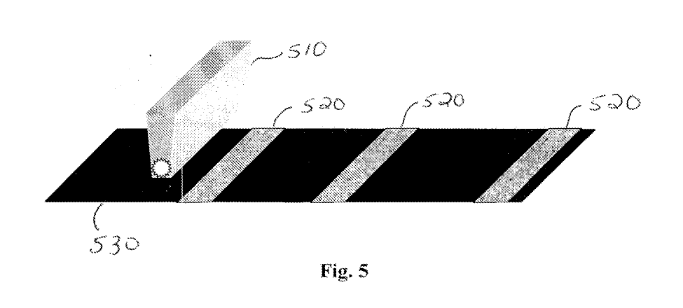

In an alternative embodiment of the process, the application of powder can be interrupted so that powder is only applied to areas where it is required. For some embodiments of this variation, the liquid application step 120 and/or the excess power removal step 130 may not be required. In another embodiment of this alternative, liquid is non-selectively applied to the entire fiber web, and powder is then selectively applied only where needed. FIG. 5 depicts this type of alternative exemplary implementation of an apparatus for powder application and excess removal, wherein powder is applied intermittently. In the embodiment of FIG. 5, powder application system 510 intermittently applies powder 520 to the feed 530 of material.

While several preferred embodiments of the invention are disclosed, many other implementations and variations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

What is claimed is:

1. A method for tow stabilization, comprising the steps of:
applying liquid to a spread fiber tow in a desired pattern, the spread fiber tow comprising a plurality of fibers arranged into a non-stabilized spread-out fiber web, wherein at least some areas of the spread fiber tow have liquid applied and at least some areas do not have liquid applied;
applying powder to the fiber web to adhere the powder to areas of the fiber web where liquid was applied;
removing powder from areas of the fiber web to which powder did not adhere; and
fusing the powder remaining on the fiber web to stabilize the arrangement of the fibers.

2. The method of claim 1, wherein the liquid is volatile.

3. The method of claim 1, wherein the step of fusing comprises heating the fiber web.

4. The method of claim 1, wherein the powder is a heat-settable polymer and the step of fusing comprises heating the fiber web

5. The method of claim 1, wherein the powder is applied in a desired pattern, wherein at least some areas of the spread fiber tow have powder applied and at least some areas do not have powder applied.

6. The method of claim 1, wherein the fibers are composed of materials selected from the group consisting of carbon fiber, ceramics, polymers, fiberglass, polyester, silk, nylon, aramid, spectra, polyethylene, and cotton.

7. The method of claim 1, wherein the method employs an apparatus for tow stabilization, the apparatus comprising:
liquid applicator, the liquid applicator being employed for the step of applying powder and being specially adapted to apply liquid to a spread fiber tow;
powder applicator, the powder applicator being employed for the step of applying powder and being specially adapted to apply the powder to the fiber web so that powder adheres to areas of the fiber web where liquid was applied;
powder remover, the powder remover being employed for the step of removing powder and being specially adapted to remove powder from areas of the fiber web to which powder did not adhere; and
powder fuser, the powder fuser being employed for the step of fusing and being specially adapted to fuse the powder remaining on the fiber web so that the arrangement of the fibers is stabilized.

8. The method of claim 7, wherein the liquid applicator is selected from the group consisting of one or more spray nozzles, applicators based on miniature solenoid valves, inkjet printing heads, and roll applicators.

9. The method of claim 7, wherein the powder remover is selected from the group consisting of one or more beater rollers, bump rollers, air blasters, vacuums, vibrators, or sound wave generators.

10. The method of claim 7, wherein the powder fuser is selected from the group consisting of one or more heat applicators and chemical reaction initiators.

11. The method of claim 7, wherein the method employs a tow comprising fibers composed of materials selected from the group consisting of carbon fiber, ceramics, polymers, fiberglass, polyester, silk, nylon, aramid, spectra, polyethylene, and cotton.

12. The method of claim 7, wherein the method employs a liquid selected from the group consisting of water, water with 2-pyrrolidone, glycols, and oils.

13. The method of claim 7, wherein the method employs a powder selected from the group consisting of polymers, thermosettable powders, nylons, polyethylenes, and polyether ether ketones.

14. A method for tow stabilization, comprising the steps of:
Applying a liquid to a spread fiber tow;
applying powder in a desired pattern to the spread fiber tow, the spread fiber tow comprising a plurality of fibers arranged into a non-stabilized spread-out fiber web, wherein at least some areas of the spread fiber tow have powder applied and at least some areas do not have powder applied;
removing powder from areas of the fiber web to which powder did not adhere; and
fusing the patterned powder on the fiber web to stabilize the arrangement of the fibers.

15. The method of claim 14, wherein the step of fusing comprises heating the fiber web.

16. The method of claim 15, wherein the powder is heat-settable.

17. The method of claim 14, wherein the fibers are composed of materials selected from the group consisting of carbon fiber, ceramics, polymers, fiberglass, polyester, silk, nylon, aramid, spectra, polyethylene, and cotton.

18. The method of claim 14, wherein the liquid is volatile.

19. The method of claim 14, wherein the liquid is applied in a desired pattern, wherein at least some areas of the spread fiber tow have liquid applied and at least some areas do not have liquid applied.
